(19) United States
(12) Patent Application Publication
(10) Pub. No.: US 2007/0095859 A1
(43) Pub. Date: May 3, 2007

(54) Controller-based management of a fluid dispensing system

(76) Inventors: Bryan A. Maser, Inver Grove Heights, MN (US); Robert E. May, Lakeville, MN (US); Kelly Doyle, Lakeville, MN (US)

Correspondence Address: SHUMAKER & SIEFFERT, P. A., 1625 RADIO DRIVE, SUITE 300, WOODBURY, MN, 55125, US

(21) Appl. No.: 11/264,585

(22) Filed: Oct. 31, 2005

(51) Int. Cl. B67D 1/08; B67D 5/08

(52) U.S. Cl. 222/148; 222/59

(57) ABSTRACT

A beverage dispensing system having control-based functionality for managing a beverage dispensing process and a cleaning process for fluid dispensing system is disclosed. The beverage dispensing system has one or more beverage containers that supply beverage(s) to beverage line(s), which in turn, supply the beverage(s) to dispense unit(s), or tap(s). A controller manages overall functionality of the system. Each beverage container includes a beverage port through which a beverage is output to an associated beverage line for communication to an associated tap. A coupler is affixed to the container and interfaces the associated beverage line to the beverage port on the container. The controller monitors flow through the beverage lines to determine whether any of the couplers are malfunctioning by allowing fluid to flow when the beverage dispensing process is disabled. The beverage lines also include fob detectors that are configured to facilitate the cleaning process.

### RELATED APPLICATIONS

This application is related to subject matter disclosed in U.S. patent application for MONITORING OPERATION OF A FLUID DISPENSING SYSTEM, Ser. No. (Attorney Docket No. 00163.2001-US-I2), U.S. patent application for CLEANING PROCESSES FOR A FLUID DISPENSING SYSTEM, Ser. No. (Attorney Docket No. 00163.2001-US-13) and U.S. patent application for CONTROLLER-BASED MANAGEMENT OF A FLUID DISPENSING SYSTEM Ser. No. (Attorney Docket No. 00163.2001-US-I4), each of which are filed on even date herewith and hereby incorporated by reference by their entirety.

### TECHNICAL FIELD

The present invention generally relates to fluid dispensing systems, and more particularly to managing operation of fluid dispensing systems.

### BACKGROUND

Conventional beer dispensing systems include beer lines through which beer is supplied from kegs to taps, which are operable to dispense the beer to drinking containers such as steins, pilsner glasses and frosty mugs. When a tap is opened, beer is dispensed from the system as a pressure is exerted into the associated keg thereby forcing beer out of the keg and into a beer line fluidly coupled to the keg by way of a keg coupler. The pressure is typically supplied by a gas source such as, for example, a tank of carbon dioxide or nitrogen or a gas blender providing a mixture of gases. Regardless of the type of gas source employed, the keg coupler interfaces the applied pressure to the keg, which is thus pressurized such that any beer contained therein is pushed up to the beer lines through the coupler. The associated tap at the other end of the beer line from the keg may then be opened thereby allowing beer to be dispensed therefrom.

Monitoring operation of such conventional beer dispensing systems is purely a manual process. As such, bartenders and restaurant managers typically spend countless hours each month performing various maintenance and operating tasks such as, for example, switching between kegs, monitoring beer usage and estimating future demand figures. In addition to standard operating tasks, beer dispensing systems require periodic cleaning. Conventional cleaning approaches involve the use of portable chemical dispense systems. In this regard, a cleaning technician will manually disconnect the beer lines from each individual keg coupler and then apply cleaning chemicals to the beer lines with the taps in the open position such that the chemicals will be distributed through the lines. Thus, a technician is required to disconnect the beer line from each keg in a beer dispensing system being cleaned, which is a daunting task indeed. Because current approaches require so much time and effort on part of the cleaning technicians, beer dispensing systems are commonly cleaned on rather lengthy time intervals. Such lengthy cleaning intervals tend to facilitate the collection of bacteria and soil in the beverage lines thereby risking contamination with the beer and potentially making it somewhat unsafe for human consumption.

Further contributing to an already inefficient process are changes to the structural configuration of conventional beer dispensing systems. For example, splitters are sometimes used to carry beer from one keg to different taps in completely different areas in a restaurant or bar. While the splitters provide certain advantages namely with respect to fewer kegs, the use of splitters in a beer dispensing system results in lengthier durations for applied cleaning processes. Another such configuration change involves the addition of fob detectors in beer lines. The fob detectors detect the presence of foamy beer in the beer lines and subsequently shut off the beer lines such that the foamy beer is not provided to the customer. Like splitters, fob detectors have certain advantages, however these devices also provide further obstacles for cleaning particularly due to the fact that, during cleaning, functionality of each fob detector in the system must be manually overridden. Accordingly, the more fob detectors, the more time a service technician must spend cleaning the system.

While only beer dispensing systems are described above, these drawbacks are commonly known to exist with respect to other types of fluid dispensing systems. As such, it is against this background that the present invention has been made relative to all types of fluid dispensing systems.

### SUMMARY OF THE INVENTION

The present invention is generally directed to a computer-implemented approach to managing operation of a fluid dispensing system. Such management may be directed to fluid dispensing processes or cleaning processes thereby providing automated control over a wide range of system functionality. To accomplish this, the fluid dispensing system includes a controller operable to receive and track information regarding operation of the system relative to both processes.

In an embodiment, the fluid dispensing system includes a fluid container having an attached coupler that interfaces the container to a fluid line for communication of fluid from the container to one or more dispense units. The coupler enables flow of the fluid from the fluid container to the fluid line in response to receipt of control gas from a controller. Management over this fluid dispensing system is administered according to an embodiment by a method that involves monitoring whether the fluid is flowing in the fluid line and, in response to detecting flow of the fluid in the fluid line, determining whether the control gas is being provided to the coupler. If the control gas is not being provided to the coupler, then a notification that the coupler is malfunctioning is issued to responsible personnel. In another embodiment, the method further involves determining whether a cleaning process is being applied to the fluid line. In this embodiment, the malfunction notification is only issued if neither the cleaning process nor the control gas are being applied to the coupler.

In another embodiment, the fluid line includes a split line valve having an input and two outputs. The first output is fluidly connected to a first dispense unit via a first output fluid line and the second output is fluidly connected to a second dispense unit via a second output fluid line. In this embodiment, the method further involves receiving an instruction that requests cleaning of the first output fluid line but that does not request cleaning of the second output fluid line. In response to such an instruction, the split line valve is controlled such that fluid is operable to flow between the fluid line and the first output fluid line but precluded from flowing between the fluid line and the second output fluid line, thereby disabling flow of fluids to and through the second dispense unit. Also, in this embodiment, the method involves issuing the malfunction notification only if neither the cleaning process nor the control gas are being applied to the fluid line.

In yet another embodiment, the fluid dispensing system includes a plurality of fluid containers each having attached couplers interfacing the containers to fluid lines for communication of fluid to a plurality of dispense units. In accordance with this embodiment, each of the plurality of fluid lines are categorized in one of a plurality of zones. The method involves monitoring whether fluid is flowing in any one of the plurality of fluid lines and, in response to detecting flow of fluid in a specific fluid line, determining which of the plurality of zones into which the specific fluid line is categorized. Next, the method involves determining whether control gas is being provided to the couplers in the determined zone. If the control gas is not being provided to the determined zone, then a notification that the coupler is malfunctioning is issued to responsible personnel. Again, in this embodiment, the method may further involve determining whether a cleaning process is being applied to the determined zone and only issuing the malfunction notification if neither the cleaning process nor the control gas are being applied to that zone.

Furthermore, in accordance with yet another embodiment, the present invention relates to an improved configuration for a fob detector for use in assisting with the cleaning process of a fluid dispensing system that utilizes one or more fob detectors. In this embodiment, the fluid dispensing system includes a fluid container from which a fluid is supplied to a dispense unit via a fluid line, a controller and a coupler that interfaces the fluid container to the fluid line and that is controllable by the controller to enable flow of the fluid from the fluid container to the fluid line, consistent with the embodiments described in the paragraphs above. Additionally, the fluid system includes at least one fob detector and at least one controllable valve having an output and two inputs. The output is fluidly connected to the dispense unit by a first portion of the fluid line. The controller is operable to select one of the two inputs to enable alternative means of communicating fluid through the controllable valve to the output port. Accordingly, these inputs are referred to herein as “selectable” inputs.

Also, in this embodiment, the fob detector includes a chamber, an input port, an output port and a cleaning port. The input port, which is fluidly connected to the coupler by way of a second portion of the fluid line, accepts the fluid from the coupler and provides the accepted fluid to the chamber. The output port is fluidly connected to the first selectable input on the controllable valve by way of an intermediate fluid line. The cleaning port is fluidly connected to the second selectable input on the controllable valve by a bypass fluid line. Using this improved configuration and the controllable valve, the controller is operable to select the second selectable input to cause fluid provided to the chamber by way of the input port to substantially fill the chamber and drain out of the cleaning port to the first portion of the fluid line. As such, the chamber of the fob detector may be cleaned along with the couplers, fluid lines and other components in the system during any applied cleaning processes.

These and various other features as well as advantages, which characterize the present invention, will be apparent from a reading of the following detailed description and a review of the associated drawings.

### BRIEF DESCRIPTION OF THE DRAWINGS

FIG. 1 is a fluid dispensing system having an integrated controller-based chemical dispense system for cleaning components of the fluid dispensing system in accordance with an embodiment of the present invention.

FIG. 2 depicts a gas-fluid junction and a coupler, and an exemplary connection therebetween for use in the fluid dispensing system shown in FIG. 1.

FIG. 3 illustrates in block diagram form a system for managing operation of a fluid dispensing system, such as the fluid dispensing system of FIG. 1, in accordance with various embodiments of the present invention.

FIG. 4 illustrates the fluid dispensing system of FIG. 1 as configured in accordance with an embodiment of the present invention to include a plurality of sensors for detecting malfunction in a coupler in the system.

FIG. 5 is a fluid dispensing system configured in accordance with an embodiment of the present invention to include a plurality of fluid lines that carry fluid from single fluid container to various points of use.

FIG. 6 illustrates modifications that may be made to a fob detector according to an embodiment of the present invention in order to assist with cleaning a fluid dispensing system into which the fob detector is installed in a fluid line.

FIG. 7 is a flow diagram illustrating operational characteristics for managing operation of the fluid dispensing system shown in FIG. 4 in accordance with an embodiment of the present invention.

FIG. 8 is a flow diagram illustrating operational characteristics for managing operation of the fluid dispensing system shown in FIG. 5 in accordance with an embodiment of the present invention.

FIG. 9 is a flow diagram illustrating operational characteristics according to an embodiment of the present invention in which at least one fob detector is controlled using the modifications shown in FIG.6.

FIG. 10 depicts a general-purpose computer that may be configured to implement logical operations of the present invention in accordance with an embodiment thereof.

### DETAILED DESCRIPTION

The present invention and its various embodiments are described in detail below with reference to the figures. When referring to the figures, like structures and elements shown throughout are indicated with like reference numerals. Objects depicted in the figures that are covered by another object, as well as the reference annotations thereto, are shown using dashed lines.

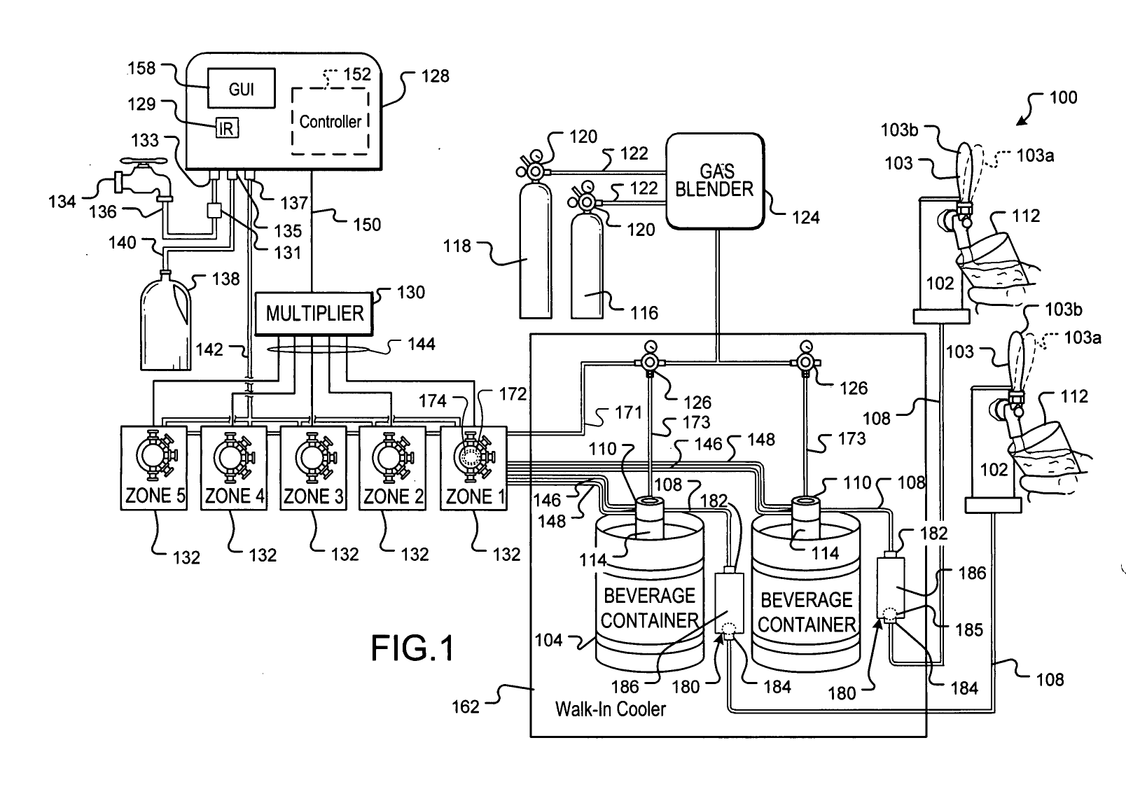

The present invention is generally directed to managing operation of a fluid dispensing system, and in accordance with a specific embodiment, a beverage dispensing system (e.g., 100 shown in FIG. 1). The beverage dispensing system 100 administers beverage-dispensing processes during which beverages are provided to dispense units 102, or “taps,” for dispensing to cups, mugs, glasses or steins for consumption by a user. Embodiments of the present invention relate to monitoring and controlling these dispensing processes in automated fashion as described in greater detail below with reference to the figures.

Also, in an embodiment, the present invention involves monitoring and controlling a chemical dispense system for use in cleaning the beverage dispensing system 100, as described in U.S. patent application Ser. No. 10/985,302 (filed Nov. 9, 2004) and Ser. No. 11/142,995 (filed Jun. 1, 2005), each of which are entitled “CHEMICAL DISPENSE SYSTEM FOR CLEANING COMPONENTS OF A FLUID DISPENSING SYSTEM” and incorporated by reference herein by their entirety. The chemical dispense system is integrated into the beverage dispensing system 100, and thus, referred to as an “in-line” cleaning system. In operation, the in-line cleaning system administers a “cleaning process” to the beverage dispensing system 100 in which the various fluid-carrying lines and components are cleaned in accordance with embodiments described in the above-referenced patent applications. With that said, the beverage dispensing system 100 is described generally below in accordance with embodiments of the present invention to include the in-line cleaning system and, thus, the present invention is applicable to monitor and control not only beverage dispensing processes, but cleaning processes as well. Those of skill in the art will therefore recognize applicability of the various embodiments of the present invention to both a stand-alone beverage dispensing system 100 and also a beverage dispensing system 100 having an in-line cleaning system.

While many different types of beverages and beverage dispensing systems are contemplated within the scope of the present invention, the beverage dispensing system 100 is described as being a beer dispensing system used to dispense beer to a bar area of a restaurant. Indeed, those of skill in the art will appreciate that the beverage dispensing system 100 is operable to dispense any other type of beverage, such as, for example, soda, juices, coffees and dairy products. Even further, the beverage dispensing system 100 may be utilized to dispense fluids other than beverages such as, for example, paint.

With the above-described environment in mind, FIG. 1 shows a beverage dispensing system 100 in accordance with an embodiment of the present invention. The beverage dispensing system 100 dispenses different labels of beer through individual dispense units 102, as shown in FIG. 1 in the form of conventional beer taps. The dispense units 102 include handles 103 that may be toggled between an “off” position 103b and an “on” position 103a, the latter of which is shown using dashed lines. While the handles 103 are in the “off” position 103b, the dispense units 102 preclude the flow of beer therefrom. Conversely, while the handles 103 are in the “on” position 103a, the dispense units 102 enable the flow of beer therefrom and preferably to some form of drinking article, such as a stein or mug 112. To illustrate embodiments of the present invention, the dispense units 102 are shown in FIG. 1 with the handles 103 in the “on” position 103a.

Prior to being dispensed, the beverages are contained in beverage containers 104. The beverage containers 104 are illustrated in FIG. 1 as being conventional-sized kegs in accordance with an embodiment of the present invention. However, any other type and size of container from which a beverage may be supplied will suffice. Whereas the dispense units 102 are preferably located in the bar area, the beverage containers 104 are stored in a cooling room, such as walk-in cooler 162, in order to direct and maintain the temperature of the beverages at a desired temperature.

Each dispense unit 102 is fluidly connected to a beverage container 104 by a beverage line 108. In accordance with an embodiment, each beverage line 108 includes a fob detector 180 (i.e., “fob”) integrated therein. Generally speaking, a fob 180 is device that detects the absence of beverages in the beverage line 108 into which it is installed and precludes further flow through the line 108 until a beverage is subsequently detected. Fobs 180 are therefore used to overcome problems realized when an associated beverage container 104 empties and any remaining beverage therein is forced out of the container 104 as a foamy substance. As is known to those skilled in the art, a fob 180 is constructed of an enclosed chamber 186 having an internal float 185 (shown in position when the fob 180 is devoid of beverage).

The enclosed chamber 186 is fluidly coupled to the associated beverage line 108 by way of a beverage input port 182 and a beverage output port 184. As beverage flows through the associated beverage line 108, the internal float 185 floats within the chamber 186 based on conventional buoyancy principles. As the associated beverage container 104 empties, gas applied to the container 104 begins to fill the beverage line 108 thereby terminating the buoyancy effect within the chamber 186, which causes the internal float 185 to drop within the chamber 186 and seal off the beverage output port 184, as shown in FIG. 1. As a result, any foamy substance accompanying the gas is not allowed to pass to the associated dispense units 102.

After the emptied beverage container 104 is replaced or, alternatively, replenished, beverage once again flows through the associated beverage line 108. Consequently, beverage begins to fill the chamber 186 thereby causing the internal float 185 to float therein and terminate the seal over the beverage output port 184. Beverage is then allowed to flow to and through the associated dispense unit 102 for dispensing to the mug 112.

Each beverage line 108 is connected to an associated beverage container 104 by a coupler 110. The couplers 110 are affixed to beverage ports 114 on the associated beverage containers 104 through which the beverages are output for direction by the couplers 110 to the associated beverage lines 108. Each coupler 110 provides functionality for opening the beverage port 114 to which the coupler 110 is affixed and introducing a pressure into the associated beverage container 104 to force the beverage contained therein through the beverage port 114 and to the associated beverage line 108. The connection provided by the coupler 110 between the beverage port 114 and the beverage line 108 is preferably air tight, and thereby operable to force the beverage through the associated beverage line 108 and to the associated dispense unit 102. Depending on the position of the dispense unit 102, dispensing of the beverage from the unit 102 is either precluded (i.e., handle 103 in “off” position 103b) or enabled (i.e., handle 103 in “on” position 103a).

The pressure used to force beverages from the beverage containers 104 to the dispense units 102 via the beverage lines 108 is supplied to the couplers 110 from one or more pressure sources, e.g., 116 and 118. These pressure sources 116, 118 are shown in accordance with an embodiment as being compressed gas tanks having different reference numerals (i.e., 116 and 118) to differentiate between the different types of gas contained by each. For example, pressure source 116 includes carbon dioxide and pressure source 118 includes nitrogen in accordance with an exemplary embodiment.

Each gas tank 116 and 118 includes a primary regulator 120. The primary regulators 120 regulate the flow of gas from the gas tanks 116, 118 to a gas blender 124 via gas lines 122. The gas blender 124 blends the gases from the gas tanks 116 and 118 and provides a mixed gas compound to secondary regulators 126. Each of the secondary regulators 126 regulate the flow of the mixed gas compound from the gas blender 124 to individual couplers 110, thereby providing the requisite pressure to force the beverages from the beverage containers 104 to the dispense units 102. As such, there exists a 1:1 correlation between secondary regulators 126 and beverage containers 104. In accordance with alternative embodiments, a single secondary regulator 126 may regulate the flow of the mixed gas compound to more than one beverage container 104.

As described above in accordance with an embodiment of the present invention, the beverage dispensing system 100 includes an in-line cleaning system that administers a cleaning process applied to the beverage dispensing system 100. The in-line cleaning system encompasses various components of the beverage dispensing system 100 such as, without limitation, the couplers 110, as well as a control system 128, a zone controller 130 (optional), various data communications lines (e.g., 150 and 144), various substance communication lines (e.g., 146 and 148) and gas-fluid junctions 132, each of which are shown generally in block diagram form in FIG. 1.

The control system 128 is a controller-based system that manages the overall administration of cleaning processes applied to the beverage dispensing system 100. In this regard, the beverage dispensing system 100 includes a controller 152 (internal to the control box 128) that controls and monitors various tasks administered by the control system 128 in performance of beverage dispensing and system cleaning processes. In accordance with an embodiment, the controller 152 is a PLC (programmable logic controller) providing hardened I/O (inputs/outputs) for the control system 128.

The control system 128 also includes one or more display devices or modules, such as, without limitation, a graphical user interface (GUI) 158. The GUI 158 allows a user to monitor and control operation of the control system 128 through a touch screen interface. For instance, the GUI 158 may present information to a user that represents the operational status of the beverage dispensing system 100 in performance of beverage dispensing processes or the in-line cleaning system in performance of cleaning processes. Such information may be in the form of icons selectable to control either process. For example, the GUI 158 may include icons selected by a user to initiate or suspend either the dispensing process or the cleaning process. Furthermore, the GUI 158 may present to the user a selection screen that enables the user to control aspects of the cleaning process by defining or modifying the phases of the cleaning process or the amount of time that each phase is to be administered. In addition, the GUI 158 may function as a security mechanism for limiting access to the control system 128 to authorized users.

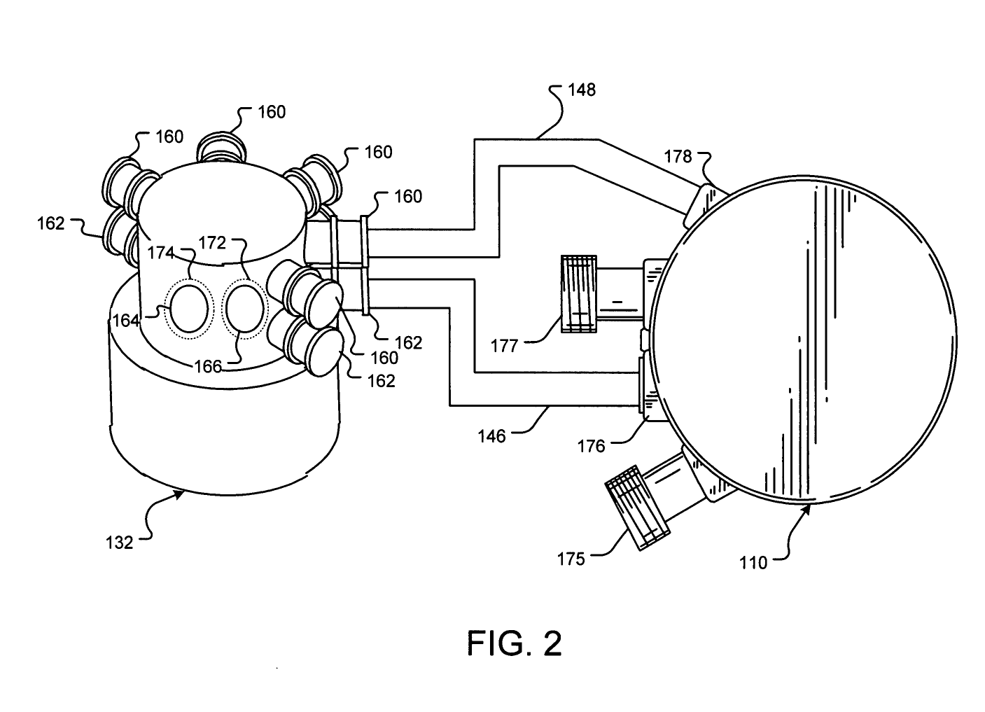

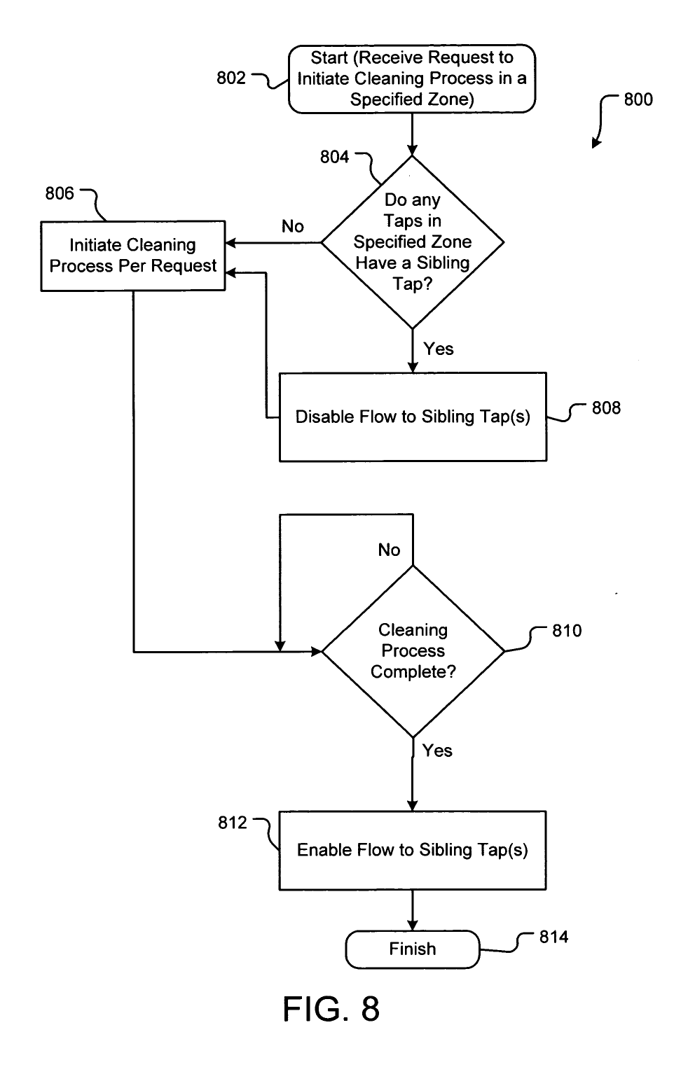

Alternatively, users may interact with the controller 152 by way of an external computer source, such as a handheld device, which may be wireless or wire-based. To effectuate the use wireless handheld devices, the control system 128 includes an infrared port 129 for communicating data to and from these devices. In yet another embodiment, the dispensing control system also includes a switching mechanism (not shown) for use in activating cleaning processes in desired zones, as described in greater detail with reference to FIGS. 2 and 8 of U.S. patent application Ser. Nos. 10/985,302 and 11/142,995, which, again, are incorporated by reference above.

The zone controller 130, which is also referred to as a “multiplier,” is a stand-alone component of the in-line cleaning system that works in combination with the GUI 158 or other data input means (e.g., external computer or switching mechanism) to activate the cleaning process in certain zones. As such, the zone controller 130 accepts user input from a source requesting the administration of one or more phases of the cleaning process to a zone and activates the phase(s) in that zone. The zone controller 130 is either an integrated circuit (IC) operable to receive and transmit signals for purposes of selecting the gas-fluid junctions 132 for activation, as described below, or a controller (e.g., PLC) programmed to receive and transmit data for these same purposes. In an alternative embodiment, the zone controller 130 may be a module integrated with the controller 152, and thus, contained within the housing of the control system 128.

The control system 128 is powered by a power source (not shown), which may be any conventional power source known to those skilled in the art. The control system 128 includes a first fluid input port 133 and a second fluid input port 135 through which water and chemical solutions, respectively, are input to the system 128. Water provided to the first fluid input port 133 is supplied by a potable water source 134 via a water input line 136. In an embodiment, a backflow prevention device 131 is positioned in the water input line 136 in order to preclude chemical solutions and contaminated water used during cleaning processes from backflowing into the potable water source 134.

Chemical solutions provided to the second fluid input port 134 are supplied from a solution container, such as a jug 138, via a solution input line 140. The control system 128 also includes a fluid output port 137 through which the water and chemical solutions are dispensed out of the system 128 by way of a fluid manifold 142. Those skilled in the art will appreciate that the control system 128 includes pumps, regulators or the like for enabling the flow of water and chemical solution into the system 128 via the water input line 136 and the solution input line 140 and subsequently out of the system 128 via the fluid manifold 142.

Water and one or more chemical solutions are provided by the control system 128 to the gas-fluid junctions 132 by way of the fluid manifold 142. The gas-fluid junctions 132, when activated by the zone controller as described below, distribute water and chemical solutions from the fluid manifold 142 to couplers 110 for distribution through the beverage lines 108, the dispense units 102 and any other component through which beverages flow. For illustration purposes, the gas-fluid junction 132 of zone 1 is shown as being connected to the beverage containers 104 by junction-coupler fluid lines 146 that carry the water and chemical solutions from this gas-fluid junction 132 to the couplers 110 when the gas-fluid junction 132 is activated.

The in-line cleaning system also includes junction-coupler gas lines 148 that carry a “control” gas from the gas-fluid junctions 132 to the associated couplers 110. Supply of the control gas to a coupler 110 dictates whether the beverage port 114 on the associated beverage container 104 is “open” or “closed,” and thus whether pressure from the gas blender 124 is allowed to enter the container 104. Consequently, the control gas dictates whether that beverage is operable to flow from the associated container 104 to the one or more corresponding dispense units 102 depending on the position (i.e., 103a or 103b) of the dispense unit(s) 103. To accomplish this, each of the couplers 110 includes a piston (not shown) that is responsive to the control gas to open the associated beverage port 114. The pressure from the gas blender 124 is constant and, as such, is substantially immediately introduced into the beverage container 104 in response to the piston opening the beverage port 114 under direction of the control gas. Conversely, termination of the supply of control gas to the couplers 110 results in the couplers 110 closing the associated beverage ports 114.

The operational state of the beverage dispensing system 100 involves the application of control gas to the couplers 110 and, during such application, beverages are operable to flow from the associated beverage containers 104 to the associated beverage lines 108 (depending, of course, on the positioning of the handles 103). Before any chemicals or water are supplied to a zone in the beverage dispensing system 100 for cleaning, supply of control gas to the couplers 110 in that zone is terminated and maintained terminated for the duration of the cleaning process. In effect, the non-application of control gas to these couplers 110 is intended to disable the flow of beverage from the associated beverage containers 104 to the associated beverage lines 108, at which time, the cleaning process may commence.

With reference now to FIG. 2, the gas-fluid junctions 132 and the couplers 110 are described in further detail. Each of the couplers 110 includes a beverage output port 177 from which beverages are supplied to an associated beverage line 108 during the beverage dispensing process. The beverage output ports 177 are fluidly coupled to the beverage lines 108 such that pressure supplied by the gas blender 124 is operable to force beverages from the beverage containers 104 to the beverage lines 108 with minimal loss.

Each of the gas-fluid junctions 132 include a fluid input port 164 and a gas input port 166. The fluid input port 164 is fluidly coupled to the fluid manifold 142 and thus accepts fluids (e.g., water and chemical solution) therefrom. In an embodiment, the gas input port 166 is coupled to the gas blender 124 by way of a control gas line 171, which is provided to each of the gas-fluid junctions 132 as generally depicted in FIG. 1. Alternatively, the gas input port 166 may be coupled directly to either gas tank 116 or 118 without going through the gas blender 124. The gas-fluid junctions 132 also include a plurality of gas output ports 160 and a plurality of fluid output ports 162. Each of the plurality of gas output ports 160 are paired with one of the plurality of fluid output ports 162.

A gas control valve 172, generally represented using dashed lines, is situated internal to each gas-fluid junction 132 and provides functionality for the gas-fluid junctions 132 to accept and reject gas from the gas blender 124. In this regard, the gas control valve 172 fluidly connects the gas input port 166 to the plurality of gas output ports 160 such that gas from the blender 124 is operable to flow therebetween. Each of the gas output ports 160 is coupled to a gas input port 178 on a coupler 110 via a junction-coupler gas line 148 such that gas may flow therebetween. The communication of gas between the output ports 160 on a gas-fluid junction 132 and the gas input ports 178 on the couplers 110 served by that gas-fluid junction 132 operates to maintain the “open” state of the beverage ports 114 on the associated beverage containers 104, as described above. Conversely, terminating supply of gas between the output ports 160 and the gas input ports 178 operates to close the beverage ports 114 on the containers 104, also as described above. By effectively providing such control, this gas is appropriately referred to throughout this description as “control gas.”

A fluid control valve 174, also generally represented using dashed lines, is situated internal to each gas-fluid junction 132 and provides functionality for the gas-fluid junctions 132 to accept and reject water and chemical solutions from the control system 128. Thus, with similar reference to the gas control valve 172, the fluid control valve 174 fluidly connects the fluid input port 164 to the plurality of fluid output ports 162 such that water and chemical solutions are operable to flow therebetween. Each fluid output port 162 is coupled to a fluid input port 176 on a coupler 110 via a junction-coupler fluid line 146 such that the water and chemical solutions may flow therebetween.

The gas control valve 172 and the fluid control valve 174 are controlled by the zone controller 130 via a low voltage line 144 input to the gas-fluid junction 132 from the zone controller 130. In normal state, i.e., when the beverage dispensing system 100 is in beverage dispensing mode, the zone controller 130 does not issue a current to any of the gas-fluid junctions 132. In response to direction from the control system 128 to apply the cleaning process to a specific zone, the zone controller 130 issues a current to the gas-fluid junction 132 served by the specified zone thereby “activating” that gas-fluid junction 132. Such activation causes the gas control valve 172 of that gas-fluid junction 132 to close, thereby rejecting gas from the gas blender 124. Consequently, the supply of control gas to the couplers 110 served by the activated gas-fluid junction 132 (i.e., the couplers 110 within the associated zone) is terminated thereby causing the pistons internal to the couplers 110 to disengage the beverage ports 114 on the associated beverage containers 104. Substantially concurrently, the issued current opens the fluid control valve 174 to enable the communication of water and chemical solutions to the associated couplers 110. However, these fluids are not provided to the activated gas-fluid junction 132 unless and until the controller 128 initiates a cleaning process within that zone.

In an embodiment, each of the couplers 110 include a pressure input port 175 through which the gas pressure supplied from the gas blender 124 is introduced to the couplers 110. As noted above, gas is provided to the pressure input ports 175 in constant fashion and used to force beverages from the beverage containers 104 to the beverage lines 108 when the pistons internal to the couplers 110 are engaged (i.e., when the control gas is “on”). In an alternative embodiment, application of the control gas by itself may provide a sufficient amount of pressure to force beverages from the containers 104 to the beverage lines 108 without the added need for pressure from the gas blender 124. In accordance with this embodiment, the gas line 171 directly connects between the gas blender 124 and the pressure input port 175 as well as the secondary regulators 126 and the connections between these regulators 126 and the couplers 110 are not necessary. The implementation is a manner of choice and, regardless of how such control is administered, termination of the control gas to a specific zone results in the same functionality, i.e., sealing the associated beverage ports 114, such that the couplers 110 in that zone exit the beverage dispensing mode and enter the cleaning mode (thus awaiting possible initiation of a cleaning process).

The couplers 110 include o-rings (not shown) or other equivalent sealing mechanisms (e.g., lip seals) operable to seal off the applicable beverage ports 114 while the couplers 110 are in the cleaning mode such that any chemicals and water applied to the couplers 110 during the cleaning process are precluded from entering the beverage containers 104. Likewise, these o-rings or equivalent sealing mechanisms are operable to seal the fluid input ports 176 while the couplers 110 are in the beverage dispensing mode such that any chemical or water residue remaining in the fluid lines 146 are precluded from mixing with beverages during the beverage dispensing process. As known to those in the art, the o-rings are round, circular membranes that perform functionality for sealing off various apertures within mechanical devices.

The o-rings, which may be constructed using a plastic or rubber material, actually serve as a secondary measure for preventing cross-contamination of water and chemicals with the beverages contained in the beverage containers 104. Indeed, the first measures for such prevention are the pistons internal to the couplers 110 or equivalent metal and/or plastic mechanical structures that move between beverage dispensing position and cleaning position in response to application and termination, respectively, of the control gas. The o-rings serve as gaskets as support to the pistons or other metal and/or plastic mechanical structures. Those of skill in the art will recognize functionality of o-rings with respect to beverage dispensing couplers as well as any viable alternatives therefor. While being secondary measures, however, failure of an o-ring can result in beverage being dispensed from the associated beverage container 104 into the beverage line 108 during cleaning as well as cleaning chemical and water residue seeping into the beverage during beverage dispensing.

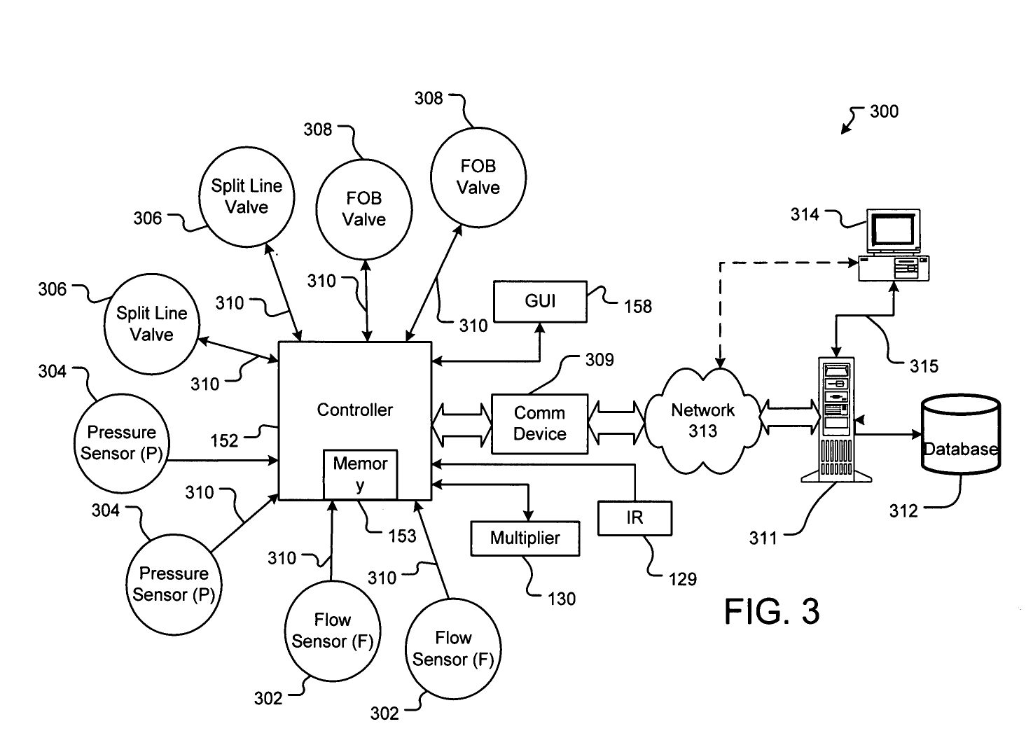

With the general environment in which embodiments of the present invention are applicable provided above, FIG. 3 depicts, in block diagram form, a system for monitoring and controlling (hereinafter, collectively referred to as “managing”) operation of the beverage dispensing system 100 of FIG. 1 in accordance with various embodiments of the present invention. The system 300 includes a plurality of sensors (e.g., flow sensors 302 and pressure sensors 304) and a plurality of electronically controllable valves (e.g., split line valves 306 and fob valves 516), each of which are communicatively connected to the controller 152 by way of data communication connections 310. In an embodiment, the data communication connections 310 are wire-based communication media operable to carry a current indicative of sensed information from the sensors 302 and 304 to the controller 152 as well as a current indicative of instructions from the controller 152 to the controllable valves 306 and 308. These data communication connections 310 may additionally or alternatively embody wireless communication technology. It should be appreciated that the manner of implementation of the data communication connections 310 is a matter of choice and the present invention is not limited to one or the other, but rather, either wireless or wire-based technology may be employed alone or in combination with the other.

The controller 152 receives information sensed by the flow sensors 302 and the pressure sensors 304 (and any other sensors) and stores this information to memory 153. The memory 153 is shown as internal to the controller 152 and embodies any form of solid state, non-volatile memory known to those skilled in the art such as, for example, Random Access Memory (RAM), Read-Only Memory (ROM), Erasable Programmable ROM (EPROM), Electrically-Erasable Programmable ROM (EEPROM), Flash Memory and Programmable ROM, etc. Alternatively, the memory 153 may take the form of storage medium readable by an external peripheral device such as, for example, a hard disk, a CD-ROM, a DVD, a storage tape, etc.

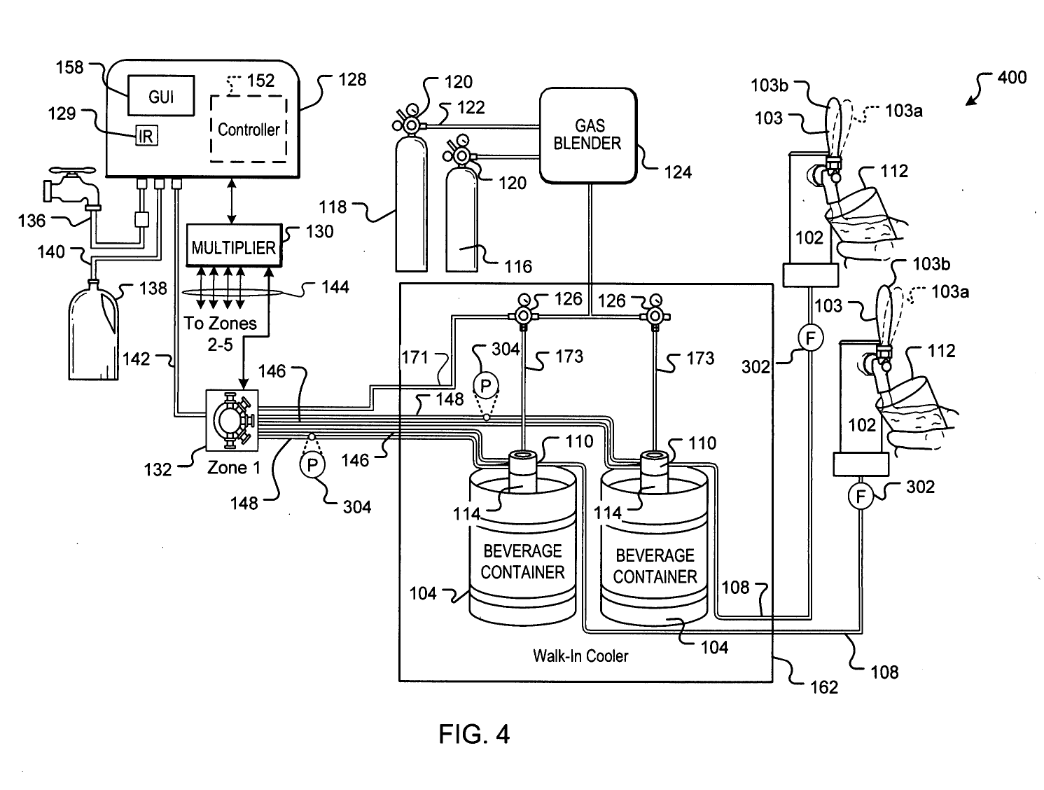

Regardless of the memory implementation, the controller 152 is operable to access the data stored on the memory 153 and analyze the data to monitor operation of the beverage dispensing system 100 by rendering conclusions regarding operation of the system 100. Furthermore, the controller 152 is operable to utilize this data along with other forms of generated or collected information to provide control over operation of the system 100. Exemplary analyses are described in greater detail in connection with FIGS. 4-9 in accordance with embodiments of the present invention.

The monitoring system 300 is shown to include parts of the dispensing control system 128 in addition to the controller 152 in accordance with an embodiment of the present invention. Specifically, the monitoring system 300 also includes the zone controller 130 (again, optional), the GUI 158 and the IR port 129. The GUI 158 and the IR port 129 provide users with access to data captured by the sensors 302 as well as any analyses performed by the controller 158 thereon. As such, user interaction is provided by touch screen interface (on GUI 158) or by way of a mobile computer such as a laptop, PDA or other handheld computing device (via IR port 129). Using the GUI 158 and/or a mobile computer interacting through the IR port (129), a user is provided with functionality for monitoring operation of the beverage dispensing system 100 as well as to view reports prepared using the sensed information.

In addition to the local user interaction provided by the GUI 158 and the IR port 129, the monitoring system 300 also provides users with the capability to monitor operation of the beverage dispensing system 100 from remote locations. To accomplish this, the monitoring system 300 includes a remote, or “server,” computer 310 communicatively connected to the controller 152 by way of a communications network 313. The server computer 311 communicates with the controller 152 to retrieve data stored on the memory 153, which may include any information sensed from the flow sensors 302 or the pressure sensors 304 and any other sensors and/or information embodying analyses (e.g., reports) of such data performed by the controller 152 including, for example, data related to control over both the beverage dispensing process and the cleaning process. Once retrieved, the information is stored on a database 312 for future access by users. In this regard, the server computer 311 functions as a user interaction mechanism much like the GUI 158 and the IR port 129, but from a remote location relative to the actual location of the system 100.

The controller 152 connects to the communications network 313 by way of a communication device 309. The communication device 309 may be a modem, a network interface card (NIC) alone or in combination with a router, hub or Ethernet port, a wireless transmitter, etc. In an embodiment of the present invention, the communication device 309 periodically accesses the server computer 311 to provide data, e.g., raw sensed data (e.g., flow readings) or reports characterizing monitoring operations, for storage in the database 312. As such, the communication device 309 may access real-time data received by the controller 152 and any historical data stored on the local memory 153 for transfer to the database 312. In an alternative embodiment, the communication device 309 maintains communications with the server computer 311 over the communications network 313 continually; therefore, the local memory 153 is unnecessary for storing sensed data. Instead, the communication device 309 continually transmits real-time sensed data to the server computer 311.

In addition to data retrieval services, the server computer 311 is also operable to perform analyses on information retrieved from the controller 152 and prepare reports characterizing these analyses in similar fashion to the functionality described for the controller 152 above. That is, the server computer 311 retrieves raw sensed data (e.g., pressure readings and flow readings) stored on the memory 153 and analyzes the retrieved information to render conclusions regarding operation of the beverage dispensing system 100 with respect to at least temperature, pressure, gas detection and flow characteristics. These conclusions are preferably placed into report format and stored on the database 312 for future access by users.

The controller 152 can also receive commands from the server computer 311 via the communications network 313 to provide a feedback loop to the control system 128. These commands may be used to control processes and operations of the beverage dispensing system 100. Such commands may include calibration commands, test commands, alarm commands, interactive communications between the system (100) operator or service technician and the server computer (311), and other remote control commands. This capability facilitates the management of multiple, geographically dispersed beverage dispense systems 100 by allowing an operator or the service technician to distribute control commands from a central location via the communications network 313.

A client computer 314, e.g., a thick or thin client, is connected to the server computer 311 by way of communication link 315 or, alternatively, the communications network 313, as shown in dashed lines. The client computer 314 communicates with the server computer 311 to retrieve data from the database 312 for presentation to a user. As such, the client computer 314 receives reports stored in the database 312 and provides these reports to a user. Alternatively, the client computer 314 may include an analysis application operable to receive raw sensed data (e.g., pressure readings, flow readings) stored in the database 312 and analyze this data to generate reports, as described above with reference to the controller 152 and the server computer 311.

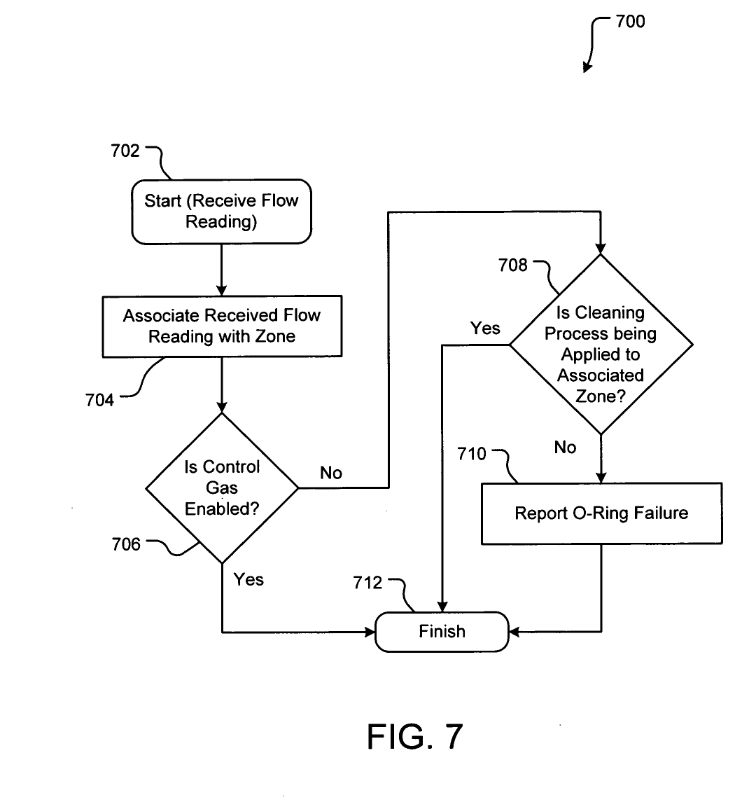

An exemplary layout of the flow sensors 302 and the pressure sensors 304 within the beverage dispensing system 100 is shown in FIG. 4 and described in conjunction therewith. More specifically, FIG. 4 depicts a system 400 for detecting failure by o-rings in the beverage dispensing system 400 using the flow sensors 302 and the pressure sensors 304 in accordance with an embodiment of the present invention. Configured in this manner, the pressure sensors 304 are operable to detect the presence and absence of the control gas to the couplers 110 and provide such information to the controller 152 by way of data communication lines 310. The controller 152 utilizes this information to determine whether the couplers 110 are internally positioned in the beverage dispensing mode. The flow sensors 302 are operable to detect the presence and absence of beverages and other fluids through the beverage lines 108 and provide such information to the controller 152 by way of data communication lines 310. As described in connection with FIG. 7, the combination of information from the pressure sensors 304 and the flow sensors 302 is used by the controller 152 to determine whether any of the o-rings in the couplers 110 within the beverage dispensing system 400 have potentially failed and thus require maintenance or servicing visit.

In accordance with an exemplary embodiment, the pressure sensors 304 are shown in FIG. 3 to detect the presence or absence of the control gas within the junction-coupler gas lines 148. However, the present invention is not limited to such placement. Rather, these pressure sensors 304 may be located in various other locations within the beverage dispensing system 400. For example, in a system 400 that does not include a zone controller 130, a single pressure sensor 304 may be used within the control system 128 that detects application/non-application of control gas to the gas-fluid junctions 132 used in the system 100.

Even further, the controller 152 may serve the function of the pressure sensors 304 such that stand alone pressure sensors 304 are not required in the system 100. In this embodiment, the controller 152 is imparted with knowledge (through its normal control processing) of which zones are currently being applied the control gas. Such an implementation is particularly effective if the zone controller 130 is an integrated feature of the controller 152. Yet further, in a beverage dispensing system 400 having only a single zone of couplers 110, the controller 152 is operable to determine whether the control gas is being applied based on the position (i.e., on or off) of the pressure valve on the gas blender 124 or, alternatively, a CO₂ tank if a single tank (e.g., 116 and 118) is used. The implementation is a matter of choice provided that the controller 152 can detect the presence and absence of control gas to the couplers 110 within the beverage dispensing system 400.

The location of the flow sensors 302, on the other hand, is more limited in that these sensors 302 are preferably positioned to detect flow through the beverage lines 108. An alternative location in accordance with at least one embodiment would be a position internal to the dispense units 102 such that detection of the beverages, cleaning chemicals and water occurs as these fluids are being output at the point of use (e.g., mug, stein, glass, cup, etc.). Regardless of the implementation, however, the resultant functionality is the detection of flow through the beverage lines 108 and the communication of such detection to the controller 152 for use thereby as described below in conjunction with FIG. 7.

With the exemplary system 300 of FIG. 3 in mind, FIG. 7 illustrates a process 700 for monitoring operation of the beverage dispensing system 400 to detect o-ring failure therein according to an embodiment of the present invention. In particular, the monitoring process 700 embodies a sequence of computer-implemented operations performed by the controller 152, the server computer 311 and/or the client computer 314, or a combination of any of these three computing modules, in accordance with embodiments of the present invention. For illustrative purposes, however, the monitoring process 700 is described herein as performed by the controller 152.

The monitoring process 700 is performed using an operation flow that begins with a start operation 702 and concludes with a terminate operation 712. The start operation 702 is initiated in response to receipt by the controller 152 of a flow reading from any one of the sensors 302 in the system 300. The flow reading indicates that a substance has been detected within a beverage line 108 to which the communicative sensor 302 is attached. In an embodiment, the flow reading further indicates not only detection of flow of a beverage, but also the volumetric rate of flow of the detected beverage. From the start operation 702, the operation flow passes to an associate operation 704.

The associate operation 704 determines the zone and, more particularly—the sensor 306, from which the flow reading originated. In an embodiment, such information is included within the communication that includes the flow reading. For example, information identifying the sensor 302 that generated the flow reading may be embodied in data transmitted by packet in conjunction with the flow reading. Alternatively, the identifying information may be the only information received within the flow reading and the controller 152 is programmed to understand that receipt of such identifying information indicates that the identified sensor 302 has measured flow at least to some extent. After the origination sensor 302 has been determined, the associate operation 704 associates the reading with the particular zone to which the determined sensor 302 belongs. If no zone controller 130 is utilized, the individual beverage lines 108 embody “zones” and, thus, the determined sensor 302 itself represents the applicable zone for purposes of the present monitoring process 500. From the associate operation, the operation flow passes to a first query operation 706.

The first query operation 706 determines whether the control gas is enabled to the zone associated with the determined sensor 302. If not, the operation flow terminates at the conclude information 712 as the detected flow is expected with the control gas “on” and, consequently, the detected flow reading does not indicate o-ring failure. Otherwise, the first query operation 706 passes the operation flow to a second query operation 708. The second query operation determines whether a cleaning process is being applied to the zone associated with the determined sensor 712. If so, then the detected flow is expected as water and/or chemical solution are currently being provided to the beverage line 108 for cleaning and, thus, the detected flow reading does not indicate o-ring failure. Otherwise, however, such a flow is not expected thereby indicating a potential o-ring failure as described above. In this instance, the operation flow passes to a notify operation 710, which notifies the appropriate personnel of the potential failure.

In an embodiment, the notify operation 710 issues an alarm to a user through the GUI 158 or server computer 311 notifying him/her of a potential o-ring failure in the beverage dispensing system 300. In particular, the notify operation 710 instructs the user of the zone in which the potential failure has been determined by specifically identifying the beverage line 108 from which the flow reading was read. From the notify operation 702, the operation flow concludes at the terminate operation 712.

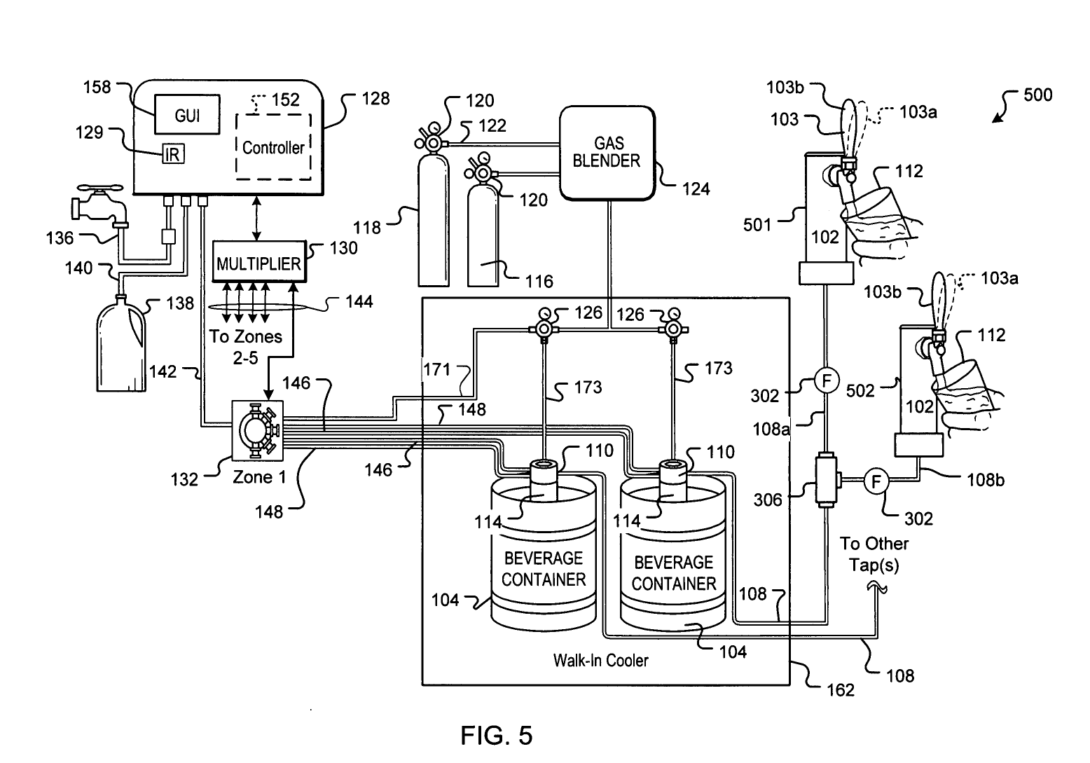

With reference back to FIG. 3, embodiments of the present invention involve the use of controllable valves (e.g., split line valves 306 and fob valves 308) to assist in managing both the beverage dispensing process and the cleaning process. FIG. 5 illustrates a beverage dispensing system 500 having a split line valve 306 positioned in a beverage line 108 and serving two dispense units 102 in accordance with an exemplary embodiment of the present invention. For illustration purposes, these dispense units 102 are separately identified in FIG. 5 using reference numerals 501 and 502. The split line valve 306 accepts beverages and other fluids (e.g., water and cleaning solutions) from the beverage line 108 and distributes the fluids to both of the dispense units 501 and 502 by way of separate output beverage lines 108a and 108b. In accordance with an embodiment, this system 500 also includes flow sensors 302 in each of the output beverage lines 108a and 108b and both of these flow sensors 302 communicate flow information to the controller 152. The split line valve 306 is controllable by the controller 152 over data communication lines 310 to selectively open and close the output beverage lines 108a and 108b. By virtue of such control, the controller 152 manages operation of the split line valve 306 to dictate whether beverages and other fluids (e.g., water and cleaning solutions) are allowed to flow to the individual dispense units 102, which is particularly advantageous with respect to the cleaning process, as described below in greater detail below in conjunction with FIG. 8.

With that said, FIG. 8 illustrates a process 800 for controlling operation of the beverage dispensing system 500 having the split line valve 306 in order to administer performance of a cleaning process. In particular, the control process 800 embodies a sequence of computer-implemented operations performed by the controller 152, the server computer 311 and/or the client computer 314, or a combination of any of these three computing modules, in accordance with embodiments of the present invention. For illustrative purposes, however, the control process 800 is described herein as performed by the controller 152.

The control process 800 is performed using an operation flow that begins with a start operation 802 and concludes with a terminate operation 814. The start operation 802 is initiated in response to receipt by the controller 152 of a request to initiate a cleaning process relative to any one zone in the beverage dispensing system 500. Such a request may embody instructions received through the GUI 158, the IR Port 129, the communication device 309 (e.g., by way of server computer 311 or client computer 314) or by way of key switches, as described in greater detail in as described in U.S. patent application Ser. No. 10/985,302 (filed Nov. 9, 2004) and Ser. No. 11/142,995 (filed Jun. 1, 2005), each of which are entitled “CHEMICAL DISPENSE SYSTEM FOR CLEANING COMPONENTS OF A FLUID DISPENSING SYSTEM” and incorporated by reference herein by their entirety. After this request has been received, the operation flow passes from the start operation 802 to a first query operation 804.

The first query operation 804 determines whether any dispense units 102 in the specified zone are coupled indirectly to a split line valve 306 by way of an output beverage line, e.g., 108a and 108b. In this case, the dispense unit 102 is said to include a “sibling” dispense unit 102 that is indirectly coupled to the same split line valve 306 by way of another output beverage line, e.g., 108a and 108b. These “paired” dispense units 102 may reside in different zones within the beverage dispensing system 500 and, as such, an embodiment involves applying the cleaning process to one of the paired dispense units 102, but not the other. In this regard, the first query operation 804 passes the operation flow to a disable operation 808 if a sibling dispense unit 102 is identified within the specified zone. Otherwise, the first query operation 804 passes the operation flow to a clean operation 806, which initiates application of the cleaning process to the specified zone per the received request. For illustration purposes, the management process 800 is described below with reference to the dispense unit 501 being within the specified zone and the dispense unit 502 being its “sibling” dispense unit.

The disable operation 808 disables the sibling dispense unit 502 by closing the internal connection within the split line valve 306 that fluidly couples the beverage line 108 to the output beverage line 108b for the sibling dispense unit 502. In an embodiment, the disable operation 808 is administered by the controller 152 issuing an instruction to the split line valve 306 over a data communication line 310, as shown and described in connection with FIG. 3. After the sibling dispense unit 502 within the specified zone has been disabled, the operation flow passes to the clean operation 806, which as noted above, initiates application of the cleaning process in the specified zone. As such, only one of the paired dispense units (i.e., 501) and its associated output beverage line 108a are cleaned during the specified cleaning process. From the clean operation 806, the operation flow passes to a second query operation 810.

The second query operation 806 determines whether the cleaning process is complete and, if so, passes the operation flow to an enable operation 812. Otherwise, the second query operation 806 passes the operation flow in a loop during which the second query operation 806 is repetitively performed until the cleaning process is complete. After such completion, the enable operation 812 enables the sibling dispense unit 502 by re-opening the internal connection within the split line valve 306 that fluidly couples the beverage line 108 to the output beverage line 108b for the sibling dispense unit 502. Like the disable operation 808, the enable operation 812 is administered by the controller 152 issuing an instruction to the split line valve 306 over a data communication line 310, as shown and described in connection with FIG. 3 in accordance with an embodiment of the present invention.

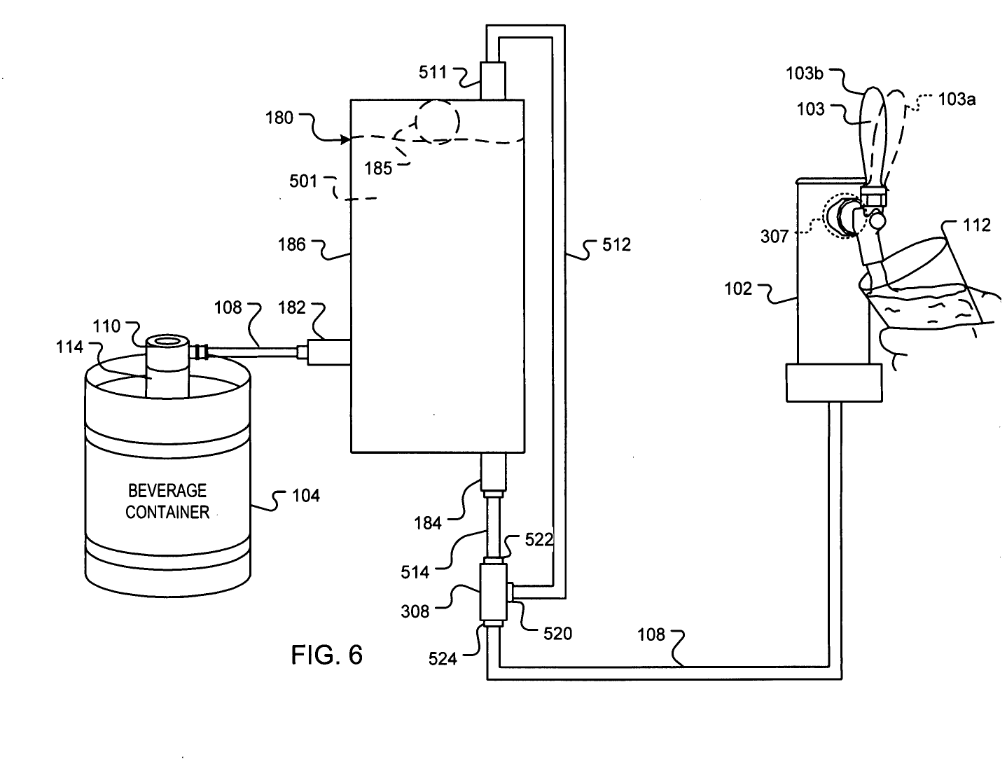

With further reference back to FIG. 3, embodiments of the present invention involve the use of fob valves 308 to assist in managing the cleaning process with respect to a beverage dispensing system 100 having fobs 180. Specifically, FIG. 6 illustrates modifications that may be made to a fob 180 to assist with the application of cleaning processes to a beverage dispensing system 100 into which the fob 180 is integrated. With that said, these modifications involve adding a cleaning port 511 to the fob 180 and coupling the cleaning port 511 to a fob valve 308 by way of a fob cleaning line 512.

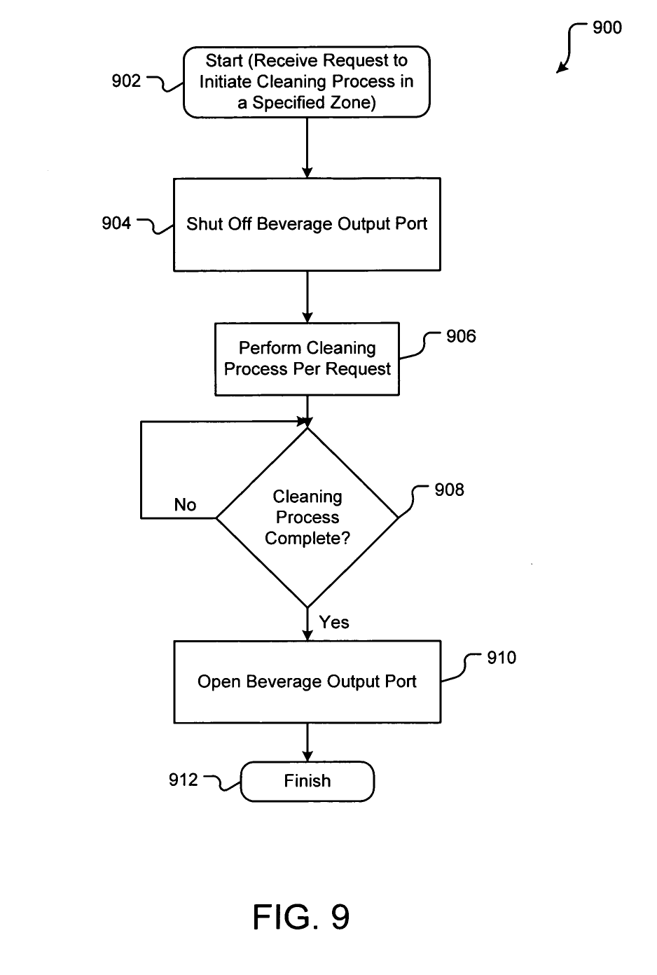

In accordance with an embodiment, the fob valve 308 is a split line valve 306 having two inputs and one output and which is electrically controlled by the controller 152 by way of data communication lines 310, as described above in connection with FIGS. 3 and 5. A first input 520 is fluidly coupled to the fob cleaning line 512 and the second input 522 is fluidly coupled to the beverage output port 184 either directly (not shown) or by way of an intermediate fluid line 514. The output 524 is fluidly coupled to the beverage line 108. Configured in this manner, the controller 152 manages operation of the fob valve 308 to force the operational state of the fob 180 into the cleaning mode (for use during the cleaning process) from its default beverage dispensing mode (for use during the beverage dispensing process), as described below in greater detail below in conjunction with FIG. 9.

Turning now to FIG. 9, a process 900 for controlling the operational state of a fob 180 in order to administer performance of a cleaning process to a resident beverage dispensing system 100 is shown in accordance with an embodiment of the present invention. In particular, the control process 900 embodies a sequence of computer-implemented operations performed by the controller 152, the server computer 311 and/or the client computer 314, or a combination of any of these three computing modules, in accordance with embodiments of the present invention. For illustrative purposes, however, the control process 900 is described herein as performed by the controller 152. Furthermore, while the control process 900 is described in connection with the toggling of the operational state of a single fob 180 into cleaning mode, it should be appreciated that the control process 800 may be implemented in numerous instances to thereby force multiple fobs 180 into cleaning mode. Indeed, such iterative or concurrent performances of the control process 900 are not only contemplated within the scope of the present invention, but expected with regard to beverage dispensing systems 100 having multiple beverage lines 108 per zone, as shown in FIG. 1 in accordance with an exemplary embodiment of the present invention.

The control process 900 is performed using an operation flow that begins with a start operation 902 and concludes with a terminate operation 912. As with the control process 800 (FIG. 8), the start operation 902 is initiated in response to receipt by the controller 152 of a request to initiate a cleaning process relative to any one zone in the beverage dispensing system 500. That said, the control process 900 (FIG. 9) may be performed concurrently or sequentially with respect to the control process 800 (FIG. 8). As both processes are mutually exclusive relative to one another, the implementation in this regard is a matter of choice. Also, as noted with the control process 800 (FIG. 8), requests to perform a cleaning process in a specified zone may embody instructions received through the GUI 158, the IR Port 129, the communication device 309 (e.g., by way of server computer 311 or client computer 314) or by way of key switches, as described in greater detail in as described in U.S. patent application Ser. No. 10/985,302 (filed Nov. 9, 2004) and Ser. No. 11/142,995 (filed Jun. 1, 2005), each of which are entitled “CHEMICAL DISPENSE SYSTEM FOR CLEANING COMPONENTS OF A FLUID DISPENSING SYSTEM” and incorporated by reference herein by their entirety. After this request has been received, the operation flow passes from the start operation 902 to a disable operation 904.

The disable operation 904 disables the internal connection within the fob valve 308 that fluidly couples the intermediate beverage line 514 to the beverage line 108. As such, the beverage output port 184 is effectively closed such that water and any cleaning solutions provided to the input port 182 of the fob 180 during the cleaning process are not communicated through the fob 180 to the dispense unit 102, but rather are directed through the cleaning port 511. Consequently, any such fluids are directed through the beverage cleaning line 512 to the beverage line 108 and out the dispense unit 102 thereby cleaning the chamber 186. In an embodiment, the disable operation 904 is administered by the controller 152 issuing an instruction to the split line valve 306 over a data communication line 310, as shown and described in connection with FIG. 3. After the connection between the intermediate beverage line 514 and the beverage line 108 has been disabled, the operation flow passes to the clean operation 906.

The clean operation 906 embodies the clean operation 806 (FIG. 8) and, therefore, initiates application of the cleaning process to the specified zone per the received request. During the cleaning process, the chamber 186 fills with water and cleaning fluids by virtue of the fob valve 308 disabling the connection between the intermediate fluid line 512 and the beverage line 108. Consequently, the applied water and fluids exit the chamber 186 through the beverage cleaning port 511 and proceed to the beverage line 108 through the beverage cleaning line 512 and the fob valve 308.

From the clean operation 906, the operation flow passes to a query operation 908. The query operation 908 determines whether the cleaning process is complete and, if so, passes the operation flow to an enable operation 910. Otherwise, the query operation 908 places the operation flow in a loop during which the first query operation 908 is repetitively performed until the cleaning process is complete. After such completion, the enable operation 910 re-opens the internal connection within the fob valve 308 that fluidly couples the intermediate fluid line 514 to the beverage line 108. Like the disable operation 904, the enable operation 910 is administered by the controller 152 issuing an instruction to the fob valve 308 over a data communication line 310, as shown and described in connection with FIG. 3 in accordance with an embodiment of the present invention.

Having described the embodiments of the present invention with reference to the figures above, it should be appreciated that numerous modifications may be made to the present invention that will readily suggest themselves to those skilled in the art and which are encompassed in the spirit of the invention disclosed and as defined in the appended claims. Indeed, while a presently preferred embodiment has been described for purposes of this disclosure, various changes and modifications may be made which are well within the scope of the present invention. For example, while described in accordance with an exemplary embodiment as applicable to beverage dispensing, as noted above, the embodiments described above are also applicable to other forms and purposes of fluid dispensing, such as, without limitation, for use in endoscope cleaning, paint dispensing and slush (e.g., ice fluid) dispensing.

In addition, embodiments for controlling fobs are illustrated herein using a conventional type fob detector 180 having a chamber 186 and an internal float 185, as shown in FIGS. 1, 4 and 5 in accordance with an exemplary embodiment. However, the present invention as it relates to fob controlling is not limited to this specific type of fob that shown in the figures and described above, but rather, it should be appreciated that controller-based management over other types of fobs are well within the scope of the present invention.

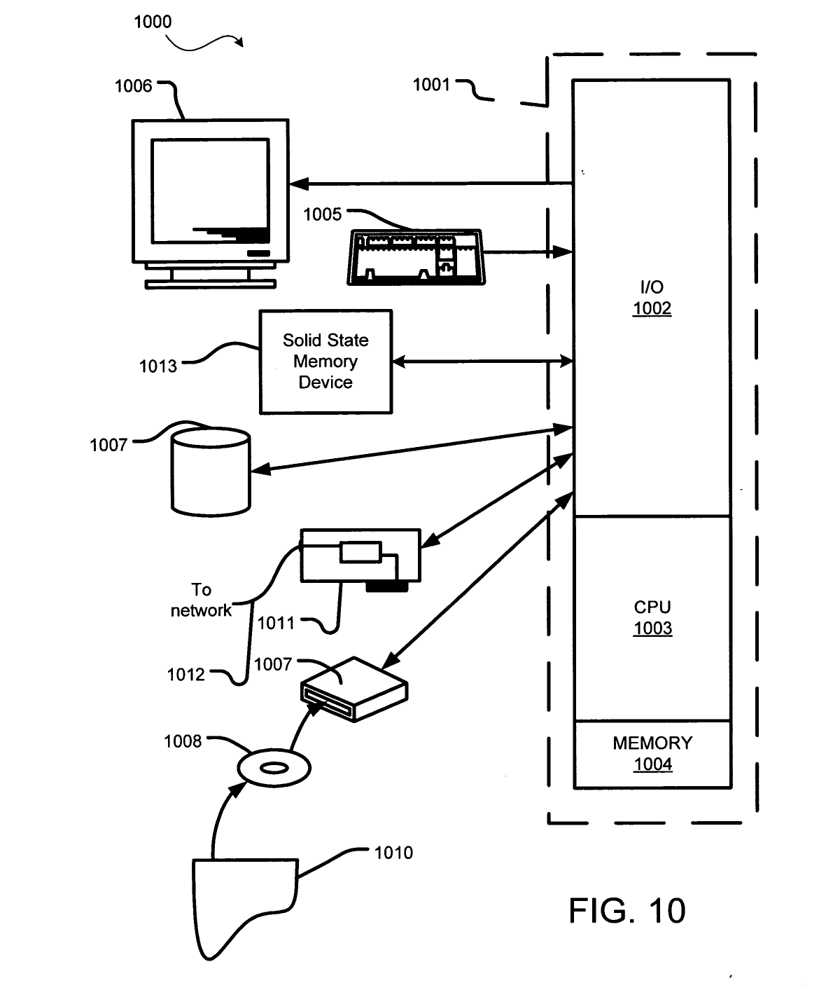

Even further, the controller 152 is described herein as conventional electrical and electronic devices/components, such as, without limitation, programmable logic controllers (PLC's) and logic components, but may alternatively be a processor 1001 integrated into a computer readable medium environment as optionally shown in FIG. 10. As such, the logical operations of the present invention described in FIGS. 7-9 may be administered by the processor 1001 in this computer readable medium environment.

Referring to FIG. 10, such an embodiment is shown by a computing system 1000 capable of executing a computer readable medium embodiment of the present invention. In such a system, data and program files may be input to the computing system 1000, which reads the files and executes the programs therein. Some of the elements of a computing system 1000 are shown in FIG. 10 wherein the processor 1001 includes an input/output (I/O) section 1002, a microprocessor, or Central Processing Unit (CPU) 1003, and a memory section 1004. The present invention is optionally implemented in this embodiment in software or firmware modules loaded in memory 1004 and/or stored on a solid state, non-volatile memory device 1013, a configured CD-ROM 1008 or a disk storage unit 1009. As such, the computing system 1000 is used as a “special-purpose” machine for implementing the present invention.

The I/O section 1002 is connected to a user input module 1005, e.g., a keyboard, a display unit 1006, etc., and one or more program storage devices, such as, without limitation, the solid state, non-volatile memory device 1013, the disk storage unit 1009, and the disk drive unit 1007. The solid state, non-volatile memory device 1013 is an embedded memory device for storing instructions and commands in a form readable by the CPU 1003. In accordance with various embodiments, the solid state, non-volatile memory device 1013 may be Read-Only Memory (ROM), an Erasable Programmable ROM (EPROM), Electrically-Erasable Programmable ROM (EEPROM), a Flash Memory or a Programmable ROM, or any other form of solid state, non-volatile memory. In accordance with this embodiment, the disk drive unit 1007 may be a CD-ROM driver unit capable of reading the CD-ROM medium 1008, which typically contains programs 1010 and data. Alternatively, the disk drive unit 1007 may be replaced or supplemented by a floppy drive unit, a tape drive unit, or other storage medium drive unit. Computer readable media containing mechanisms (e.g., instructions, modules) to effectuate the systems and methods in accordance with the present invention may reside in the memory section 1004, the solid state, non-volatile memory device 1013, the disk storage unit 1009 or the CD-ROM medium 1008. Further, the computer readable media may be embodied in electrical signals representing data bits causing a transformation or reduction of the electrical signal representation, and the maintenance of data bits at memory locations in the memory 1004, the solid state, non-volatile memory device 1013, the configured CD-ROM 1008 or the storage unit 1009 to thereby reconfigure or otherwise alter the operation of the computing system 1000, as well as other processing signals. The memory locations where data bits are maintained are physical locations that have particular electrical, magnetic, or optical properties corresponding to the data bits.

In accordance with a computer readable medium embodiment of the present invention, software instructions stored on the solid state, non-volatile memory device 1013, the disk storage unit 1009, or the CD-ROM 1008 are executed by the CPU 1003. In this embodiment, these instructions may be directed toward administering application of a cleaning process, customized or non-customized, to a beverage dispensing system. Data used in the analysis of such applications may be stored in memory section 1004, or on the solid state, non-volatile memory device 1013, the disk storage unit 1009, the disk drive unit 1007 or other storage medium units coupled to the system 1000.

In accordance with one embodiment, the computing system 1000 further comprises an operating system and usually one or more application programs. Such an embodiment is familiar to those of ordinary skill in the art. The operating system comprises a set of programs that control operations of the computing system 1000 and allocation of resources. The set of programs, inclusive of certain utility programs, also provide a graphical user interface to the user. An application program is software that runs on top of the operating system software and uses computer resources made available through the operating system to perform application specific tasks desired by the user. The operating system is operable to multitask, i.e., execute computing tasks in multiple threads, and thus may be any of the following: any of Microsoft Corporation's “WINDOWS” operating systems, IBM's OS/2 WARP, Apple's MACINTOSH OSX operating system, Linux, UNIX, etc.

In accordance with yet another embodiment, the processor 1001 connects to the communications network 313 by way of a network interface, such as the network adapter 1011 shown in FIG. 10. Through this network connection, the processor 1001 is operable to transmit information to the remote computer 310, as described in connection with the controller 152 shown in FIG. 3. Various types of information may be transmitted from the processor 1001 to the remote computer 310 over the network connection. In addition, the network adaptor 1011 enables users at the remote computer 310 or the client computer 314 the ability to issue commands to the processor 1001 if so desired, also as described above in connection with the controller 152 shown in FIGS. 1 and 4.

Additionally, while the flow sensors 306 are described herein as being operable to detect the presence or absence of fluid through the beverage lines 108, it should be appreciated that the flow sensors 306 may be as advanced as to determine the type and rate of flow (rather than just presence or absence thereof) of fluids through the beverage lines 108. In accordance with such an embodiment, the flow sensors 306 may also be operable (in connection with processes in the controller 152) to determine the percent concentration of fluids through the beverage line 108 such that identification of cleaning chemicals or water within dispensed beverages may be identified or vice-versa. Such advanced information may therefore be used in the detection process 700 to detect o-ring failure.

Furthermore, the management process 800 is described in connection with the zone specified for cleaning having only one pair of sibling dispense units 501 and 502 for illustration purposes. It should be appreciated, however, that more pairs are contemplated within the scope of the present invention. Indeed, if the specified zone includes more than one set of paired dispense units (e.g., 501 and 502), then the disable operation 808 disables the split line valve 306 for each of these pairs and subsequently, the enable operation 812 enables the split line valve 306 for each of these pairs.

In addition, while the management process 800 is described with reference to controlling one or more split line valves 306 for use in applying the cleaning process to a specified zone, it should be appreciated that embodiments of the present invention involve other forms of monitoring and controlling that may be administered over the split line valves 306. For example, the controller 152 may selectively open and close the internal connection between either of the output beverage lines 108a or 108b and the input beverage line 108 as a means to enable the beverage dispensing process with respect to one of the paired dispense units, e.g., 501, but not the other, e.g., 502.

What is claimed is:

1. A computer-implemented method for monitoring operation of a fluid dispensing system, wherein a fluid stored in a fluid container is supplied by an attached coupler to a fluid line for communication to one or more dispense units, the coupler enabling flow of the fluid from the fluid container to the fluid line in response to receipt of a control gas from a controller, the computer-implemented method comprising:
monitoring whether the fluid is flowing in the fluid line;
in response to detecting flow of the fluid in the fluid line, determining whether the control gas is being provided to the coupler; and
issuing notification of malfunction in the coupler if the control gas is not being provided to the coupler.

2. A computer-implemented method for monitoring operation of a fluid dispensing system as defined in claim 1, wherein the determining act comprises:
determining whether a cleaning process is being applied to the fluid line; and
wherein the issuing act is performed if neither the cleaning process is being applied to the fluid line nor the control gas being provided to the coupler.

3. A computer-implemented method for monitoring operation of a fluid dispensing system as defined in claim 1, wherein the issuing act comprises:
transmitting an alarm to responsible personnel over a network connection.

4. A computer-implemented method for monitoring operation of a fluid dispensing system as defined in claim 1, wherein the fluid dispensing system comprises a user interface for providing users interaction with the controller, the issuing act comprising:
presenting an alarm to at least one user on the user interface.

5. A computer-implemented method for monitoring operation of a fluid dispensing system as defined in claim 4, wherein the user interface is a graphical user interface.

6. A computer-implemented method for monitoring operation of a fluid dispensing system as defined in claim 1, wherein the fluid line comprises a split line valve having an input and two outputs, the first output being fluidly connected to a first dispense unit via a first output fluid line and the second output being fluidly connected to a second dispense unit via a second output fluid line, the method further comprising:
receiving an instruction that requests cleaning of the first output fluid line but that does not request cleaning of the second output fluid line;
in response to the instruction, controlling the split line valve such that fluid is operable to flow between the fluid line and the first output fluid line but precluded from flowing between the fluid line and the second output fluid line thereby disabling flow through the second dispense unit;
determining whether a cleaning process is being applied to the fluid line; and
wherein the issuing act is performed if neither the cleaning process is being applied to the fluid line nor the control gas being provided to the coupler.

7. A computer-implemented method for monitoring operation of a fluid dispensing system as defined in claim 6, further comprising:
in response to the controlling act, administering the cleaning process by providing a substance to the fluid line for communication to the first output fluid line, wherein the issuing act is not performed while the cleaning process being applied.

8. A computer-implemented method for monitoring operation of a fluid dispensing system as defined in claim 7, further comprising:
in response to the administering act, determining whether the cleaning process is complete; and
in response to determining that the cleaning process is complete, controlling the split line valve such that fluid is operable to flow between the fluid line and both the first and the second output fluid lines.

9. A computer-implemented method for monitoring operation of a fluid dispensing system as defined in claim 7, wherein the substance comprises water.

10. A computer-implemented method for monitoring operation of a fluid dispensing system as defined in claim 1, wherein the fluid is a beverage.

11. A computer-implemented method for monitoring operation of a fluid dispensing system as defined in claim 1, wherein the malfunction in the coupler relates to failure by a sealing mechanism.

12. A computer-implemented method for monitoring operation of a fluid dispensing system, wherein fluids stored in a plurality of fluid containers are supplied by attached couplers to a plurality of fluid lines for communication to a plurality of dispense units, the couplers each enabling flow of a fluid from an associated fluid container to an associated fluid line in response to receipt of control gas from a controller, wherein each of the plurality of fluid lines are categorized in one of a plurality of zones, the computer-implemented method comprising:
monitoring whether fluid is flowing in any one of the plurality of fluid lines;
in response to detecting flow of fluid in a specific fluid line, determining which of the plurality of zones into which the specific fluid line is categorized;
determining whether the control gas is being provided to the couplers in the determined zone; and
issuing notification of malfunction in the coupler associated with the specific fluid line if the control gas is not being provided to the determined zone.

13. A computer-implemented method for monitoring operation of a fluid dispensing system as defined in claim 12, wherein the determining act comprises:
determining whether a cleaning process is being applied to the determined zone; and
wherein the issuing act is performed if neither the cleaning process is being applied to the determined zone nor the control gas being provided to the coupler associated with the specific fluid line.

14. A computer-implemented method for monitoring operation of a fluid dispensing system as defined in claim 12, wherein the issuing act comprises:
transmitting an alarm to responsible personnel over a network connection.

15. A fluid dispensing system having a fluid container from which a fluid is supplied to a dispense unit via a fluid line, the system comprising:
a controller;
a coupler interfacing the fluid container to the fluid line and controllable by the controller to enable flow of the fluid from the fluid container to the fluid line;
a controllable valve having an output fluidly connected to the dispense unit by a first portion of the fluid line and a first selectable input and a second selectable input, wherein the controller is operable to select one of the first selectable input and the second selectable input for communicating fluid through the controllable valve to the output port; and
a fob detector comprising:
a chamber;
an input port fluidly connected to the coupler by way of a second portion of the fluid line, wherein the input port accepts the fluid from the coupler and provides the accepted fluid to the chamber;
an output port fluidly connected to the first selectable input on the controllable valve by way of an intermediate fluid line; and
a cleaning port fluidly connected to the second selectable input on the controllable valve by a bypass fluid line, wherein a fluid provided to the chamber by way of the input port substantially fills the chamber and is provided out of the cleaning port to the first portion of the fluid line via the controllable valve in response to selection by the controller of the second selectable input.

16. A fluid dispensing system as defined in claim 15, wherein the controller selects the second selectable input in response to receipt of a request to apply a cleaning process to the fluid line and wherein the fluid provided to the chamber during the cleaning process comprises water.

17. A fluid dispensing system as defined in claim 15, wherein the controller transmits information to the controllable valve by way of at least one data communication medium.

18. A fluid dispensing system as defined in claim 15, wherein the data communication medium is comprises a wireless link.

19. A fluid dispensing system as defined in claim 15, wherein the controller maintains selection of the first selectable input during a fluid dispensing process in which fluid from the container is operable for dispensing from the dispense unit.

20. A fluid dispensing system as defined in claim 19, wherein the fluid is a beverage.
